(19) United States
(12) Patent Application Publication
(10) Pub. No.: US 2004/0030820 A1
(43) Pub. Date: Feb. 12, 2004

(54) Combinational universal serial USB transmission structure

(76) Inventor: Ching-I Lan, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/215,008

(22) Filed: Aug. 9, 2002

(51) Int. Cl. G06F 13/00

(52) U.S. Cl. 710/300

(57) ABSTRACT

A combinational universal serial bus (USB) transmission structure mainly includes a control unit consisting of at least a USB interface and a driving IC. The control unit is provided with an I/O connector, which may be connected to or replaced with a corresponding I/O connector provided on, for example, a flash memory module, a card reader module, a hub module, and/or other externally connected expansion modules. Therefore, when the control unit is to be used in different functional conditions, it may be connected to or replaced with different expansion modules via the I/O connectors to achieve multiple functions and reduce the manufacturing cost for the USB transmission structure.

### BACKGROUND OF THE INVENTION

The present invention relates to a combinational universal serial bus (USB) transmission structure, and more particularly to a USB transmission structure that includes one control unit adapted to connect to or replace different externally connected working modules to reduce manufacturing cost of the USB transmission structure.

A general USB usually has an expansion module externally connected thereto in a manner as shown in FIG. 1. The expansion module may be, for example, a flash memory 13, a card reader 14, a hub 15, or any other expansion module 16. Each of the externally connected expansion modules and its control unit 1 are provided with independent USB interface 11, driving integrated circuit (IC), etc. to form an independent product for use in different USB transmission. That is, each expansion module would require a separate control unit 1. Thus, a conventional USB transmission structure as shown in FIG. 1 has repeatedly provided components to form unnecessary waste and increased manufacturing cost and becomes less competitive in the market.

FIG. 2 shows another conventional USB transmission structure having been developed to improve the first one shown in FIG. 1. This second type of conventional USB transmission structure includes a control unit 2 with an additional connecting port. The control unit 2 includes a microprocessor 21, a flash memory 22, a driving stage 23, and a USB control circuit 24. The control unit 2 is additionally provided with a USB connecting port 25 for another USB expansion module to serially connect thereto. While the second type of USB transmission structure improves some of the disadvantages of the first type USB transmission control unit shown in FIG. 1, it fails to avoid waste of resources and reduce the manufacturing cost thereof because all the expansion modules thereof still have repeatedly provided control unit 2 and other components.

### SUMMARY OF THE INVENTION

It is a primary object of the present invention to provide a combinational USB transmission structure having only one control unit that is adapted to connect to or replace different externally connected expansion modules. That is, the combinational USB transmission structure of the present invention has a common control unit to provide multiple replaceable functions at reduced manufacturing cost.

To achieve the above and other objects, the low cost USB transmission structure of the present invention mainly includes a control unit consisting of at least a USB interface and a driving IC. The control unit is provided with an input/output (I/O) connector, which may be connected to or replace a corresponding I/O connector provided on, for example, a flash memory module, a card reader module, a hub module, and/or other externally connected expansion modules. Therefore, when the control unit is to be used in different functional conditions, it may be connected to or replace different expansion modules via the I/O connectors to achieve multiple functions and reduce the manufacturing cost for the USB transmission structure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional USB transmission structure;

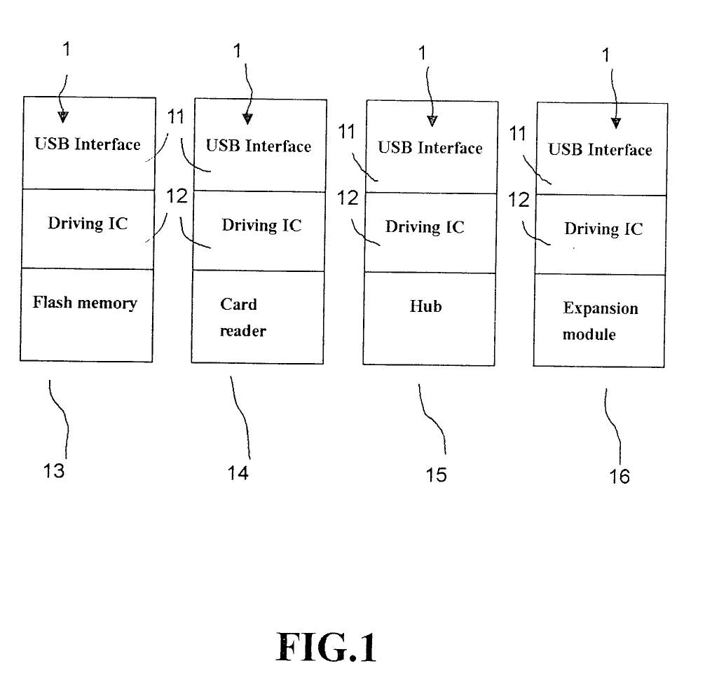

FIG. 2 is a block diagram of another conventional USB transmission structure; and

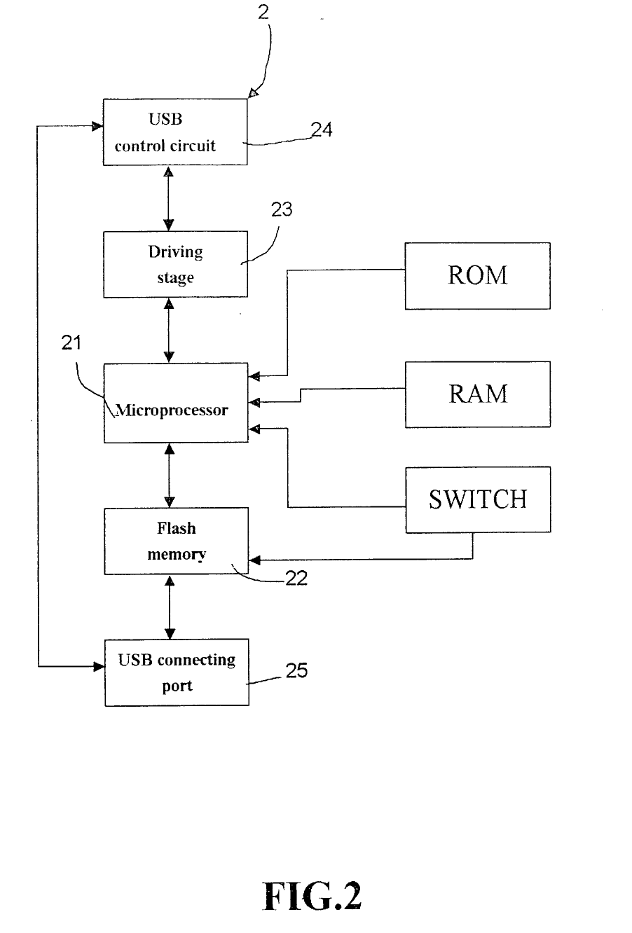

FIG. 3 is a block diagram of a combinational USB transmission structure according to the present invention.

### DETAILED DESCRIPTION OF THE PREFERRED EMBODIMENTS

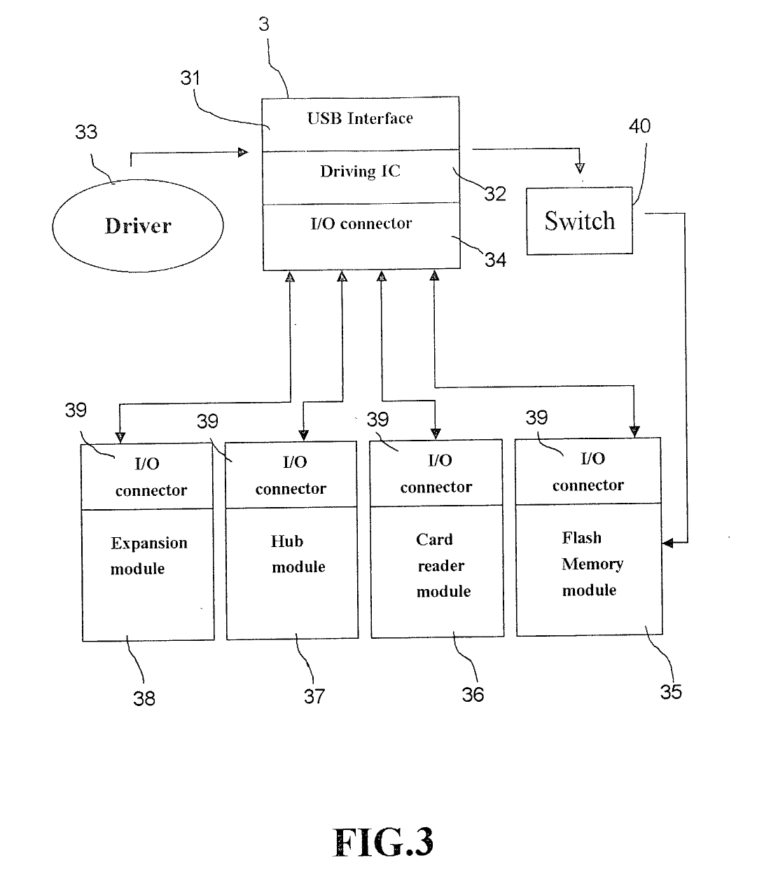

Please refer to FIG. 3 that is a block diagram of a combinational universal serial bus (USB) transmission structure according to the present invention. As shown, the combinational USB transmission structure of the present invention mainly includes a control unit 3 consisting of a USB interface 31, a driving integrated circuit (IC), and a driver 33. The control unit 3 is provided with an input/output (I/O) connector 34.

A flash memory module 35, a card reader module 36, a hub module 37, and/or an expansion module 38 of any type are separately provided with an I/O connector 39 corresponding to the I/O connector 34 of the control unit 3. Thus, when it is desirable for the control unit 3 to work with one of these different working modules, it is possible to connect or replace the I/O connector 34 to or with an I/O connector 39 for the desired module, so that only one single control unit 3 is enough to control and transmit multiple types of modules without the need of repeatedly providing the same control unit 3 on each module. Costs for manufacturing the USB transmission structure can therefore be reduced.

The above-described control unit 3 is connected to each different module via a switch 40 in order to control starting and ending of a signal transmission. Of course, it is understood the above-mentioned modules are only some examples particularly illustrated for describing the present invention. Other transmission modules with different functions may also employ the present invention to achieve the same transmission effect.

In brief, the present invention is characterized in providing connectors on the USB control unit and different transmission modules, so that only one single control unit is enough for working with multiple types of working modules via connecting or replacing the I/O connector for the control unit to or with the I/O connector for the working module. Repeated components may be minimized to reduce manufacturing cost of the USB transmission structure, enabling the present invention to be a novel design very practical for use.

What is claimed is:

1. A combinational universal serial bus (USB) transmission structure, comprising a control unit consisting of at least a USB interface and a driving integrated circuit (IC), a plurality of working modules, including, for example, a flash memory module, a card reader module, a hub module, and/or other expansion modules, to or with which said control unit may be connected or replaced; said combinational USB transmission structure being characterized in that said control unit and said a plurality of working modules are provided with corresponding input/output (I/O) connectors, so that said only one control unit is possibly connected to or replaced with two or more types of different expansion modules via said correspondingly provided I/O connectors, eliminating repeatedly provided components for said USB transmission structure and enabling reduced manufacturing cost thereof.
